(19) United States
(12) Patent Application Publication
(10) Pub. No.: US 2018/0146701 A1
(43) Pub. Date: May 31, 2018

(54) Variable Food Product Cooker and Chiller

(71) Applicant: D.M. Advantage, Inc., Vernon, CA (US)

(72) Inventor: Matthew Cheyne, Perth (AU)

(21) Appl. No.: 15/363,423

(22) Filed: Nov. 29, 2016

(51) Int. Cl. A23L 3/36

(52) U.S. Cl. CPC A23L 3/36; A23V 2002/00

(57) ABSTRACT

A food processing system is disclosed including a cooker including a first conveyor wherein food is cooked, a first chiller including a second conveyor wherein the food is chilled, a second chiller including a third conveyor wherein food is chilled, and a variable speed controller that controls the third conveyor to run at a different speed from the first conveyor. The first conveyor and the second conveyor preferably run at a same speed. The first chiller and the second chiller may be in fluid communication. In other aspects, the system further includes holes that allow the fluid to pass between the first chiller and the second chiller and flaps over the holes. The variable speed controller preferably ensures that the food exits the system with a pre-determined level of chilling, water weight, or both. Also, associated methods are disclosed.

### CROSS-REFERENCE TO RELATED APPLICATION

Not applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

The present disclosure generally relates to cooking and chilling systems, for example to prepare lobster, crab, chicken, or other food for commercial delivery.

### SUMMARY

Aspects of the subject technology include a food processing system having at least a cooker including a first conveyor wherein food is cooked, a first chiller including a second conveyor wherein the food is chilled, a second chiller including a third conveyor wherein the food is chilled, and a variable speed controller that controls the third conveyor to run at a different speed from the first conveyor. The first conveyor and the second conveyor preferably run at a same speed. Cooling coils may be used to cool fluid used by the first chiller and the second chiller. In addition, a pump for the fluid may be included, and the first chiller and the second chiller preferably are in fluid communication. The fluid communication may be via holes that allow the fluid to pass between the first chiller and the second chiller. Flaps may be placed over the holes to help facilitate proper fluid flow. The fluid may be water or brine cooled to just above freezing. In preferred aspects, the variable speed controller ensures that the food exits the system with a pre-determined level of chilling, water weight, or both.

The system may also include a ram for lowering and raising baskets of the food to allow quick ingress into the second chiller. The ram or other aspects of the subject technology may be modification(s) of an existing food processing system to increase throughput by adding the second chiller and the variable speed controller. The subject technology also includes methods that may be used by the system.

This brief summary has been provided so the nature of the invention may be understood quickly. Additional or different steps than those set forth in this summary may be used. A more complete understanding of the invention may be obtained by reference to the following description in connection with the attached drawings.

### BRIEF DESCRIPTION OF THE DRAWINGS

FIG. 1 illustrates a prior art system.

FIGS. 2 and 3 illustrate aspects of the subject technology including a second chiller.

FIG. 4 illustrates additional aspects of the subject technology.

FIG. 5 illustrates further aspects of the subject technology.

FIG. 6 illustrates some alternative aspects of the subject technology.

FIG. 7 illustrates a side view of certain aspects depicted in FIG. 6.

FIG. 8 illustrates the subject technology disposed in a space such as a building or ship.

FIG. 9 illustrates a flowchart for aspects of the subject technology.

### DETAILED DESCRIPTION

Aspects of the subject technology include a food processing system having at least a cooker including a first conveyor wherein food is cooked, a first chiller including a second conveyor wherein the food is chilled, a second chiller including a third conveyor wherein the food is chilled, and a variable speed controller that controls the third conveyor to run at a different speed from the first conveyor. The first conveyor and the second conveyor preferably run at a same speed. Cooling coils may be used to cool fluid used by the first chiller and the second chiller. In addition, a pump for the fluid may be included, and the first chiller and the second chiller preferably are in fluid communication. The fluid communication may be via holes that allow the fluid to pass between the first chiller and the second chiller. Flaps may be placed over the holes to help facilitate proper fluid flow. The fluid may be water or brine cooled to just above freezing. In preferred aspects, the variable speed controller ensures that the food exists the system with a pre-determined level of chilling, water weight, or both.

The system may also include a ram for lowering and raising baskets of the food to allow quick ingress into the second chiller. The ram or other aspects of the subject technology may be modification(s) of an existing food processing system to increase throughput by adding the second chiller and the variable speed controller. The subject technology also includes methods that may be used by the system.

In preferred aspects, various elements such as the baskets, gondolas, and the like are perforated to permit submersion thereof and the food without issues of buoyancy.

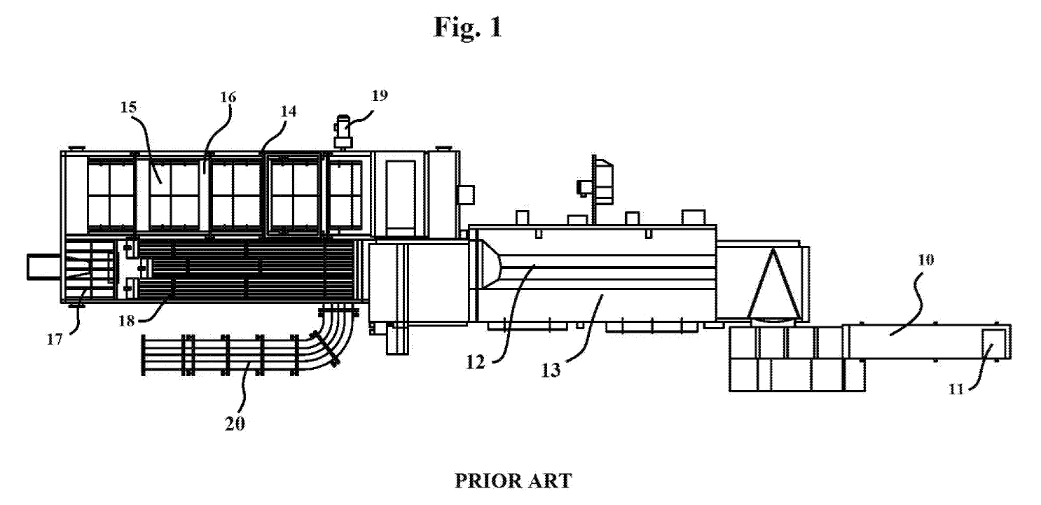

In more detail, FIG. 1 illustrates a prior art system. Food such as lobster, crab, chicken, or other food is carried on conveyor 10 by baskets such as basket 11 to cooker 12. The baskets may be placed in gondolas manually or by the system. Conveyor 13 conveys the food through the cooker. The food then passes to chiller 14, for example carried in gondolas 15 that hold the baskets. Conveyor 16 may be used to convey the food through the chiller and may pass the baskets through cooling fluid such as water or brine. The fluid may be pumped into chiller 14 by pump 17, with the fluid chilled by coils 18. Ram 19 such as an air ram then may push the food (e.g., in the baskets) to discharge ramp 20.

One possible problem with the system shown in FIG. 1 is that conveyor 13 and conveyor 16 typically move at a same speed. Unfortunately, chilling often takes longer than cooking. Thus, the overall throughput of the system may be slowed to accommodate the longer chilling time. Also, the arrangement of the cooker and chiller may necessitate a larger space for the system as opposed to aspects of the subject technology. If an inadequate amount of space exists for the chiller, then not only is proper chilling an issue but also weight gain is lost because the cook to chill time is not the same. Moreover, the variability of the food processed may be limited and/or pre-determined based on the length of the cooker and chiller.

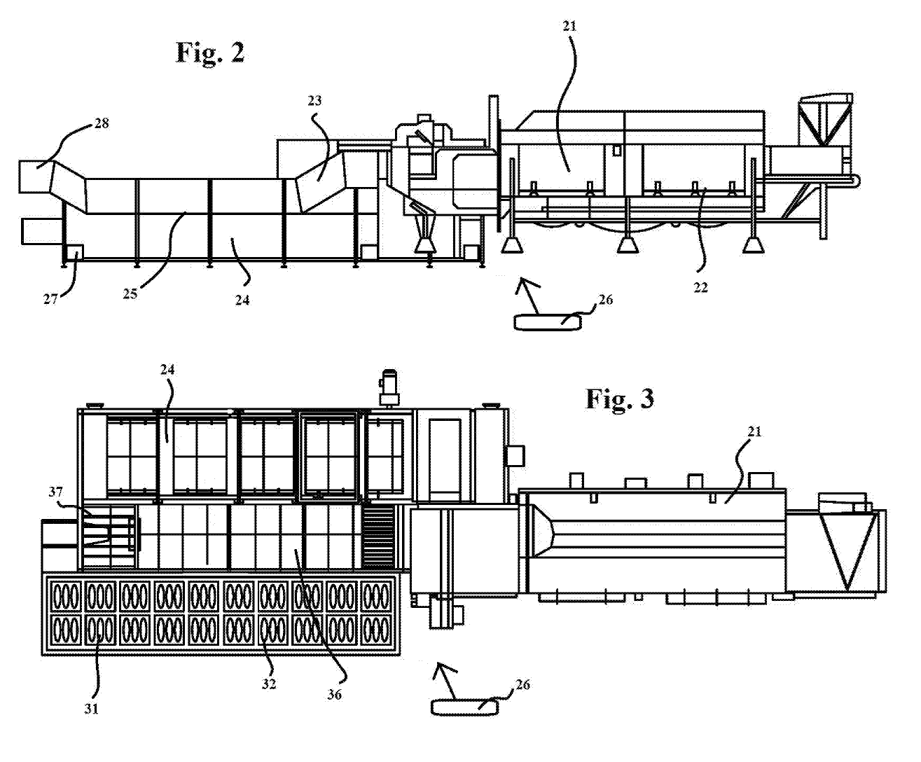

FIGS. 2 and 3 illustrate aspects of the subject technology including a second chiller. FIG. 2 shows the second chiller in partial cut-away view for ease of description. Food enters cooker 21 on conveyor 22, for example in baskets carried on gondolas. The food passes from the cooker down ramp 23 to chiller 24. As shown in FIG. 2, the food may be carried through the chiller via conveyor 25. The down ramp 23 as well as off ramp may be part of conveyor 25.

The food may pass through the second chiller after going through the first chiller. The second chiller may convey food therein on a variable speed belt drive driven by a variable speed motor 27 and controlled by variable speed controller 26. The food may then exit via exit 28, for example while still in the baskets.

The food preferably is immersed in fluid in the chillers, for example water or brine chilled to near freezing as explained further below. Alternatively, cold air and/or spraying may be used.

FIG. 3 is a top view of the system shown in FIG. 2. Certain elements such as cooker 21 and chiller 24 are repeated for ease of understanding correspondence between FIG. 2 and FIG. 3. Also shown is the second chiller, namely chiller 31 with food 32 held therein. Holes (not shown) between chilled fluid tank 36 and the second chiller exist to allow chilled water to flow from that tank to the second chiller. As one possible result of this arrangement, one chilled fluid tank 36 with chilling coils (not shown) may be used to pump chilled fluid into the chillers via a single pump 37.

The use of the second chiller and the variable speed controller may permit better throughput because the cooker may not need to wait for the longer chilling process typically required by the first chiller. In addition, because the controller is variable speed, better achievement of a pre-determined level of chilling, water weight in the food, or both may be achieved.

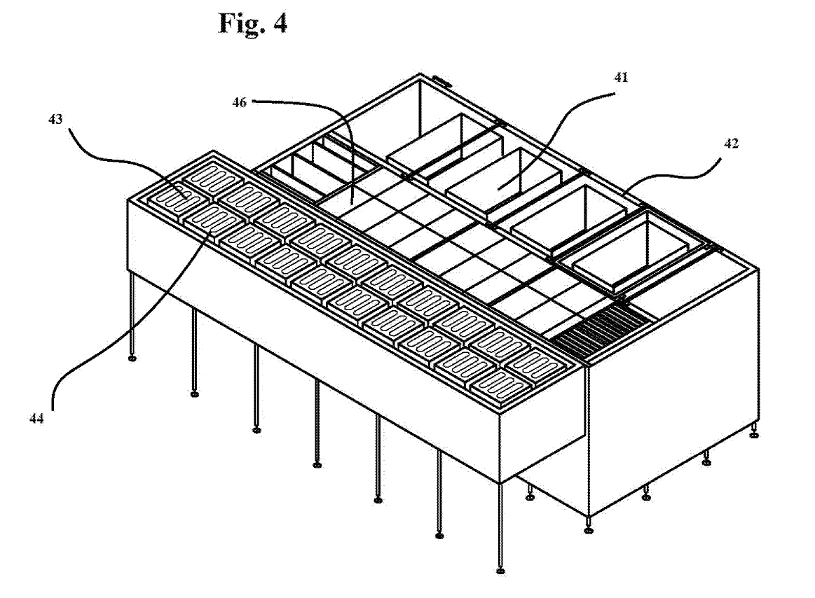

FIG. 4 illustrates additional aspects of the subject technology. The arrangement shown in FIG. 4 may be disposed in a smaller (length wise) space than the arrangement shown in FIG. 1. Gondolas 41 for food are shown disposed in chiller 42. The gondolas pass through that chiller to chiller 44, which further illustrates baskets 45 for the food in the gondolas. Chilled fluid tank 46 preferably provides chilled fluid such as water or brine to both chillers.

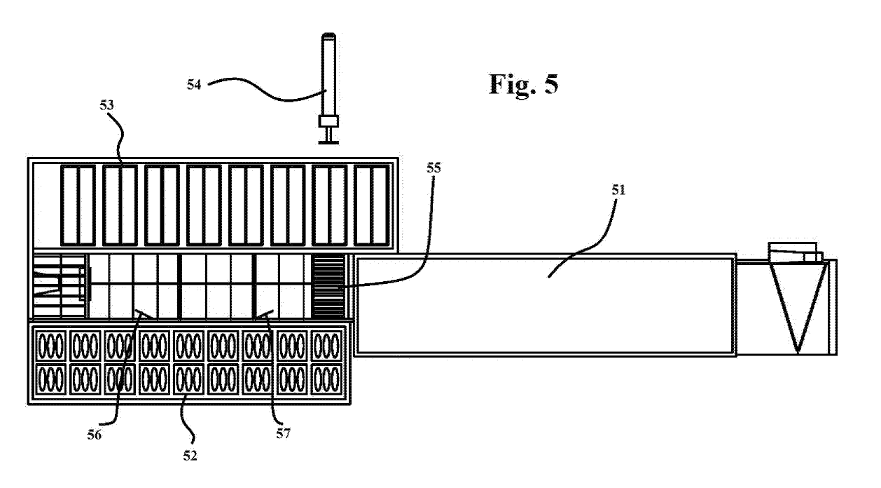

FIG. 5 illustrates further aspects of the subject technology. Food passes from cooker 51 to a first chiller and then to a chiller 52 (referred to as the “second chiller” herein). The food may wait in chiller 52 to “catch up” with throughput, preferably under control of a variable speed controller such as described above. Ram 54 then pushes the food over rollers 55 to an exit ramp (not shown).

Holes/flaps 56 and 57 between the chilled fluid tank and chiller 52 are also shown. Any number of holes and/or flaps may be used.

The “second chiller” in FIG. 3, 4, or 5 may be “bolted on” to existing systems such as the one shown in FIG. 1. Thus, the subject technology may be considered a modification or improvement of prior art systems. The second chiller, holes from a chiller fluid tank to the second chiller, flaps for the holes, passages for the food, a variable speed controller and variable speed motor in communication with a conveyor in the second chiller may be added to achieve the improved systems described herein. Alternatively, aspects of the subject technology may be included in entirely new systems.

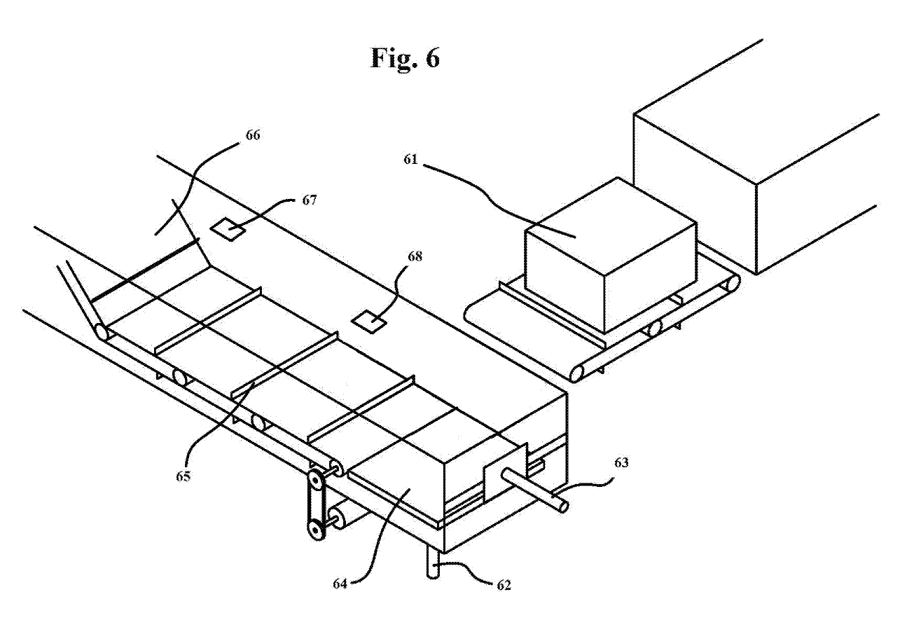

FIG. 6 illustrates some alternative aspects of the subject technology. These aspects may eliminate need for ramp 23 shown in FIG. 2. Instead of using such a ramp, the illustrated aspects use an additional ram arrangement. In more detail, food 61 (again preferably in a gondola and/or baskets) passes to a conveyor for chiller. Ram 62 such as an air ram drops and/or lifts the food into and/or outside of the chiller, for example via plate 4. Ram 63 such as an air ram pushes the food onto the conveyor.

Flaps 65 that assist with properly moving the food are shown. In addition, FIG. 5 also illustrates holes/flaps 67 and 68 to a chilled fluid tank, as discussed above. The food exits via ramp 66.

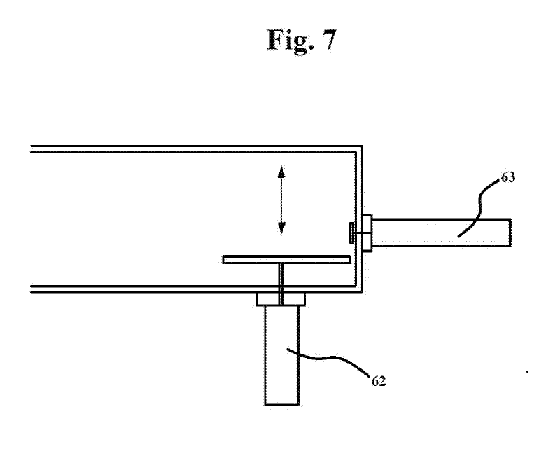

FIG. 7 illustrates a side view of certain aspects depicted in FIG. 6. In particular, FIG. 7 illustrates a side view of rams 62 and 63.

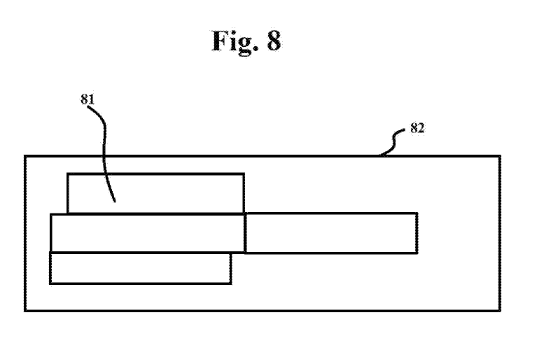

FIG. 8 illustrates the subject technology disposed in a space such as a building or ship. System 81 according to aspects of the subject technology is depicted inside a structure 82. As discussed herein, certain aspects of the technology permit a more compact arrangement while permitting improved throughput. Thus, the subject technology may fit into a smaller structure 82. This benefit may be particularly important if the structure is a building with a fixed footprint, a ship with a fix hull size, or the like. Also, smaller buildings and/or ships may be built to accommodate aspects of the subject technology while still achieving good throughput.

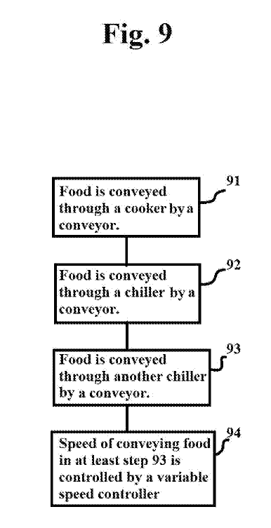

FIG. 9 illustrates a flowchart for aspects of the subject technology. Food is conveyed by a conveyor through a cooker in step 91. The food is conveyed by a conveyor through a chiller in step 92. The food is conveyed by a conveyor through another chiller in step 93. Step 94 represents use of a variable speed controller to control conveying the food in at least step 93. Alternatively, other aspects of conveying the food may be controlled by the variable speed controller to enhance throughput. Additional possible aspects of methods according to the subject technology are explained above.

The invention is in no way limited to the specifics of any particular embodiments and examples disclosed herein. For example, the terms “aspect,” “example,” “preferably,” and the like denote features that may be preferable but not essential to include in some embodiments of the invention. In addition, details illustrated or disclosed with respect to any one aspect of the invention may be used with other aspects of the invention. Additional elements or steps may be added to various aspects of the invention or some disclosed elements or steps may be subtracted from various aspects of the invention without departing from the scope of the invention. Singular elements/steps imply plural elements/steps and vice versa. Some steps may be performed serially, in parallel, in a pipelined manner, or in different orders than disclosed herein. Many other variations are possible that remain within the content, scope, and spirit of the invention, and these variations would become clear to those skilled in the art after perusal of this application.

What is claimed is:

1. A food processing system comprising:
a cooker including a first conveyor wherein food is cooked;
a first chiller including a second conveyor wherein the food is chilled;
a second chiller including a third conveyor wherein the food is chilled; and
a variable speed controller that controls the third conveyor to run at a different speed from the first conveyor.

2. A food processing system as in claim 1, wherein the first conveyor and the second conveyor run at a same speed.

3. A food processing system as in claim 1, wherein further comprising cooling coils that cool fluid used by the first chiller and the second chiller.

4. A food processing system as in claim 1, further comprising a pump for fluid, wherein the first chiller and the second chiller are in fluid communication.

5. A food processing system as in claim 4, further comprising holes that allow the fluid to pass between the first chiller and the second chiller.

6. A food processing system as in claim 5, further comprising flaps over the holes.

7. A food processing system as in claim 5, wherein the fluid comprises water cooled to just above freezing.

8. A food processing system as in claim 1, wherein the variable speed controller ensures that the food exits the system with a pre-determined level of chilling, water weight, or both.

9. A food processing system as in claim 8, further comprising a ram that lowers and raises baskets holding the food into the second chiller.

10. A food processing system as in claim 1, wherein the food processing system comprises modification of an existing food processing system to increase throughput by adding the second chiller, the variable speed controller, and the third conveyor.

11. A food processing method comprising:
cooking food in a cooker on a first conveyor;
chilling the food in a first chiller including a second conveyor;
chilling the food in a second chiller including a third conveyor; and
using a variable speed controller that controls the third conveyor to run at a different speed from the first conveyor.

12. A food processing method as in claim 11, wherein the first conveyor and the second conveyor run at a same speed.

13. A food processing method as in claim 11, further comprising use of cooling coils to cool fluid used by the first chiller and the second chiller.

14. A food processing method as in claim 11, wherein the first chiller and the second chiller are in fluid communication.

15. A food processing method as in claim 14, further comprising allowing the fluid to pass through holes between the first chiller and the second chiller.

16. A food processing method as in claim 15, further comprising using flaps to control passage of the fluid through the holes.

17. A food processing method as in claim 15, wherein the fluid comprises water cooled to just above freezing.

18. A food processing method as in claim 11, wherein the variable speed controller ensures that the food exits the system with a pre-determined level of chilling, water weight, or both.

19. A food processing method as in claim 18, further comprising using a ram to lower and raise baskets holding the food into the second chiller.

20. A food processing method as in claim 11, wherein the food processing method comprises modification of an existing food processing method to increase throughput by adding the second chiller, the variable speed controller, and the third conveyor.
